(19) United States
(12) Patent Application Publication
(10) Pub. No.: US 2014/0192446 A1
(43) Pub. Date: Jul. 10, 2014

(54) ELECTROSTATIC DISCHARGE PROTECTION DEVICE AND METHOD FOR MANUFACTURING THE SAME

(71) Applicant: SAMSUNG ELECTRO-MECHANICS CO., LTD., Suwon-si (KR)

(72) Inventors: Sung Kwon WI, Suwon-si (KR); Young Seuck YOO, Suwon-si (KR); Kyong Bok MIN, Suwon-si (KR); Won Chul SIM, Suwon (KR); Young Do KWEON, Suwon (KR)

(73) Assignee: SAMSUNG ELECTRO-MECHANICS CO., LTD., Suwon-si (KR)

(21) Appl. No.: 14/147,220

(22) Filed: Jan. 3, 2014

(30) Foreign Application Priority Data
Jan. 4, 2013 (KR) 10-2013-0001089

(51) Int. Cl. H02H 9/04

(52) U.S. Cl. CPC H02H 9/04
USPC 361/56; 29/592.1

(57) ABSTRACT

Disclosed herein is an electrostatic discharge protection device including: a substrate; electrodes disposed to be spaced apart from each other on the substrate; and an electrostatic discharge absorbing layer having atypical metal lumps formed on the substrate.

### CROSS REFERENCE(S) TO RELATED APPLICATIONS

This application claims the benefit under 35 U.S.C. Section 119 of Korean Patent Application Serial No. 10-2013-0001809, entitled “Electrostatic Discharge Protection Device and Method for Manufacturing the Same” filed on Jan. 4, 2013, which is hereby incorporated by reference in its entirety into this application.

### BACKGROUND OF THE INVENTION

1. Technical Field

The present invention relates to an electrostatic discharge protection device and a method for manufacturing the same, and an electrostatic discharge protection device capable of improving manufacturing efficiency of a functional layer, and a method for manufacturing the same.

2. Description of the Related Art

An electrostatic discharge (ESD) protection device protecting predetermined electronic components from electrostatic discharge has been widely used. As an example, there is an electronic discharge protection device having a structure in which it includes a substrate, electrodes disposed to be spaced apart from each other by a predetermined gap on the substrate, an insulating layer covering the substrate, the electrodes, a functional layer provided on the substrate or the insulating layer, and the like. The functional layer is provided in order to absorb surge current generated in the substrate to guide the absorbed surge current to a ground layer. As an example, the functional layer may be provided in a form of a conductive thin film on an interface between the substrate and the insulating layer. As another example, the functional layer may also be provided by forming the insulating layer using a metal composite material.

### RELATED ART DOCUMENT

### Patent Document

(Patent Document 1) Japanese Patent Laid-Open Publication No. 2006-114801

### SUMMARY OF THE INVENTION

An object of the present invention is to provide an electrostatic discharge protection device having improved electrostatic discharge protection characteristics.

Another object of the present invention is to provide an electrostatic discharge protection device having a functional layer in a new structure capable of substituting for an existing functional layer.

Still another object of the present invention is to provide a method for manufacturing an electrostatic discharge protection device having improved manufacturing process efficiency.

Still another object of the present invention is to provide a method for manufacturing an electrostatic discharge protection device capable of preventing manufacturing efficiency of a functional layer from being decreased by making it difficult to uniformly distribute metal powders in a composite as compared with the case in which the functional layer is implemented using a metal-composite material.

According to an exemplary embodiment of the present invention, there is provided an electrostatic discharge protection device including: a substrate; electrodes disposed to be spaced apart from each other on the substrate; and an electrostatic discharge absorbing layer having atypical metal lumps formed on the substrate.

Each of the metal lumps may be made of any one metal selected from a group consisting of palladium (Pd), rhodium (Rh), silver (Ag), gold (Au), cobalt (Co), nickel (Ni), and copper (Cu).

The electrostatic discharge protection device may further include an insulating layer covering the substrate and the electrodes, wherein the metal lumps are formed along an interface between the substrate and the insulating layer.

The metal lumps may be irregularly distributed on the substrate and the electrode.

The metal lumps may have a width of 50 nm to 1 μm.

An occupied area of the metal lumps may be 5 to 85% with respect to the substrate.

The metal lumps may be results formed by performing heat treatment on a metal thin film covering the substrate.

The electrostatic discharge protection device may further include an insulating layer covering the electrodes, wherein the insulating layer is made of a resin based material.

According to another exemplary embodiment of the present invention, there is provided a method for manufacturing an electrostatic discharge protection device, the method including: preparing a substrate; forming electrodes disposed to be spaced apart from each other on the substrate; forming a metal thin film covering the substrate; and heat-treating the metal thin film to transform the metal thin film into atypical metal lumps.

In the forming of the metal thin film, at least any one of a sputtering process, an electron beam evaporation process, a thermal evaporation process, a laser molecular beam epitaxy (L-MBE) process, and a pulsed laser deposition (PLD) may be performed.

The metal thin film may be formed to have a thickness of 10 nm to 200 nm.

The heat-treating of the metal thin film may include heating the metal thin film at a temperature of 300 to 500° C.

The heat-treating of the metal thin film may be performed so that the metal lumps has a width of 50 nm to 1 μm.

The heat-treating of the metal thin film may be performed so that an occupied area of the metal lumps is 5 to 85% with respect to the substrate.

### BRIEF DESCRIPTION OF THE DRAWINGS

FIG. 1 is a cross-sectional view showing an electrostatic discharge protection device according to an exemplary embodiment of the present invention;

FIG. 2 is a plan view showing the electrostatic discharge protection device shown in FIG. 1;

FIG. 3 is a flow chart showing a method for manufacturing an electrostatic discharge protection device according to the exemplary embodiment of the present invention;

FIGS. 4A to 4C are views for describing a process for manufacturing an electrostatic discharge protection device according to the exemplary embodiment of the present invention;

FIG. 5 is a photograph showing a metal thin film for forming an electrostatic discharge absorbing layer in the process for manufacturing an electrostatic discharge protection device according to the exemplary embodiment of the present invention; and

FIG. 6 is a photograph showing metal lumps of the electrostatic discharge absorbing layer in the process for manufacturing an electrostatic discharge protection device according to the exemplary embodiment of the present invention.

### DESCRIPTION OF THE PREFERRED EMBODIMENTS

Various advantages and features of the present invention and methods accomplishing thereof will become apparent from the following description of embodiments with reference to the accompanying drawings. However, the present invention may be modified in many different forms and it should not be limited to the embodiments set forth herein. Rather, these embodiments may be provided so that this disclosure will be thorough and complete, and will fully convey the scope of the invention to those skilled in the art. Like reference numerals throughout the specification denote like elements.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

Further, the exemplary embodiments described in the specification will be described with reference to cross-sectional views and/or plan views that are ideal exemplification figures. In the drawings, the thickness of layers and regions is exaggerated for efficient description of technical contents. Therefore, exemplified forms may be changed by manufacturing technologies and/or tolerance. Therefore, the exemplary embodiments of the present invention are not limited to specific forms but may include the change in forms generated according to the manufacturing processes For example, a region vertically shown may be rounded or may have a predetermined curvature.

Hereinafter, an electrostatic discharge protection device and a method for manufacturing the same according to an exemplary embodiment of the present invention will be described in detail with reference to the accompanying drawings.

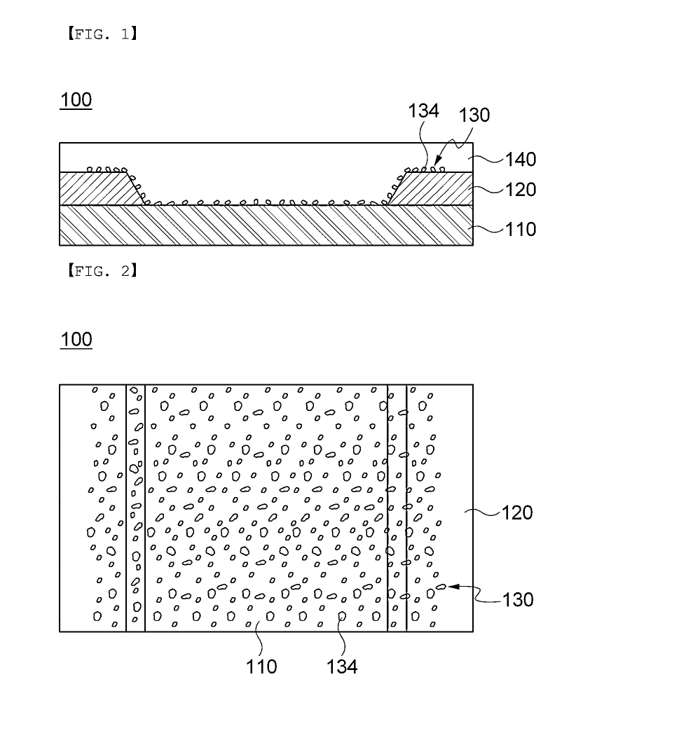

FIG. 1 is a cross-sectional view showing an electrostatic discharge protection device according to an exemplary embodiment of the present invention; and FIG. 2 is a plan view showing the electrostatic discharge protection device shown in FIG. 1.

Referring to FIGS. 1 and 2, the electrostatic discharge protection device 100 according to the exemplary embodiment of the present invention may be configured to include a substrate 110, electrodes 120, an electrostatic discharge absorbing layer 130, and an insulating layer 140.

The substrate 100 may be a base for manufacturing components 120, 130, and 140 of the electrostatic discharge protection device 100. As the substrate 100, an insulating substrate may be used. As the substrate 110, a ceramic sheet, a varistor sheet, a substrate made of a liquid crystal polymer material, other various kinds of insulating sheets, or the like, may be used. Alternatively, as the substrate 110, a magnetic substrate such as a ferrite substrate may also be used.

The electrodes 120 may have an electronic structure in which they are disposed to be spaced from each other on the substrate 110. As an example, the electrodes 120 may include a first electrode disposed on one side of the substrate 110 and a second electrode 124 disposed on the other side of the substrate 110 and facing the first electrode. The electrodes 120 may be made of various kinds of metals. As an example, the electrodes 120 may be metal patterns made of copper (Cu).

The electrostatic discharge absorbing layer 130 may be used as a functional layer absorbing or blocking electrostatic discharge (ESD). More specifically, the electrostatic discharge absorbing layer 130, which is to allow surge current to flow to a ground layer connected to the electrodes 120 at the time of generation of the surge current in the electrostatic discharge protection device 100, may have an insulating property before the generation of the surge current and generate a current path through which the surge current may flow only at the time of the generation of the surge current.

The insulating layer 140 may cover and protect the substrate 110, the electrostatic discharge absorbing layer 130, and the electrodes 120. The insulating layer 140 may be made of various insulating materials. As an example, the insulating layer 140 may be made of various kinds of resins such as a polyimide resin or a polymer resin.

Meanwhile, the electrostatic absorbing layer 130 may have a plurality of metal lumps 134. The metal lumps 134 may be distributed along an interface between the substrate 110 and the insulating layer 140 and an interface between the electrodes 120 and the insulating layer 140. The metal lumps 134 may be formed by heat-treating the metal thin film formed on the substrate 110. Therefore, the metal lumps 134 may be disposed to be spaced apart from each other at irregular gaps and be provided in a form of grain made of metal particles, respectively.

The metal lumps 134 may be made of various metal materials. For example, the metal lumps 134 may be made of any one metal selected from a group consisting of palladium (Pd), rhodium (Rh), silver (Ag), gold (Au), cobalt (Co), tin (Sn), and nickel (Ni). The metal lumps 134 may be made of any one single metal selected from the group consisting of the above-mentioned metals. However, alternatively, the metal lumps 134 may also be made of an alloy of at least two selected from the group consisting of the above-mentioned metals.

The metal lumps 134 may have various shapes. For example, the metal lumps 134 may be provided in an atypical form in which shapes thereof are not uniform. However, it is preferable that the metal lumps 134 do not have a complete spherical shape, but have a shape in which a width thereof in a lateral direction of the substrate 110 is larger than a height in an upward direction of the substrate 110. As the shape of the metal lumps 134 becomes more similar to a sphere, a thickness of the electrostatic discharge absorbing layer 130 becomes thicker, such that a function of the metal lumps 134 as the functional layer may be deteriorated. In addition, since the metal lumps 134 are formed by heat-treating (for example, reflow-treating) the metal thin film, as the shape of the metal lumps 134 becomes more similar to the sphere, a gap between the metal lumps 134 is increased, such that the function of the metal lumps 134 as the functional layer may be deteriorated.

Each of the metal lumps 134 may have a width of about 50 nm to 1 μm. In the case in which the width of the metal lumps 134 is less than 50 nm, the metal lumps 134 may have a shape similar to the spherical shape. In this case, the function of the metal lumps 134 as the functional layer may not be performed. On the other hand, in the case in which the width of the metal lumps 134 exceeds 1 μm, sufficient heat treatment is not performed on the metal thin film for forming the metal lumps 134, such that the function of the metal lumps 134 as the functional layer according to the exemplary embodiment of the present invention may be interpreted to be insufficient. In this case, electrical connection between the metal lumps 134 is easy, such that the metal lumps 134 have conductivity even in a state in which surge current is not generated. Therefore, a problem such as a short-circuit, or the like, may be generated.

In addition, the metal lumps 134 may occupy an area of about 5 to 85% in a predetermined region on the substrate 110. In the case in which the occupied area of the metal lumps 134 is less than about 5%, an amount of metal lumps 134 is significantly small, such that electrical conductivity is significantly low. Therefore, the function of the metal lumps 134 as the functional layer may not be performed. In addition, in the case in which the occupied area of the metal lumps 134 exceeds about 85%, an amount of metal lumps 134 is significantly large, such that electrical conductivity is significantly high. Therefore, the function of the metal lumps 134 as the functional layer may not be performed.

The electrostatic discharge absorbing layer 130 having the above-mentioned structure may have a structure in which atypical metal lumps 134 form a current path through which the surge current may flow in the case where noise due to high voltage from the outside is generated, thereby absorbing the surge current through a ground layer formed on the electrode layers 120. Therefore, the electrostatic discharge protection device 100 may have a structure in which distribution, an occupied area, a vertical height, a horizontal width, and the like, of the metal lumps 134 are adjusted to adjust electrical conductivity of the electrostatic discharge absorbing layer 130, thereby making it possible to adjust performance of the functional layer.

As described above, the electrostatic discharge protection 100 according to the exemplary embodiment of the present invention may include the electrodes 120 disposed to be spaced apart from each other on the substrate 110 and the electrostatic discharge absorbing layer 130 absorbing the electrostatic discharge (ESD) on the substrate, wherein the electrostatic discharge absorbing layer 130 may be formed of the metal lumps 134 provided in atypical irregular distribution. In this case, the distribution, the occupied area, the vertical height, the horizontal width, and the like, of the metal lumps 134 are adjusted to adjust the electrical conductivity of the electrostatic discharge absorbing layer 130, thereby making it possible to adjust the performance of the functional layer. Therefore, since the electrostatic discharge protection device according to the exemplary embodiment of the present invention includes the metal lumps generating the current path allowing the surge current to flow the ground layer at the time of generation of the surge current, the electrical conductivity may be easily adjusted as compared with the case in which the functional layer is implemented using a single metal thin film, and a problem that it is difficult to uniformly distribute metal powders in a metal-resin composite may be solved as compared with the case in which the functional layer is implemented using the metal-resin composite, or the like.

Next, a process for manufacturing the electrostatic discharge protection device 100 according to the exemplary embodiment of the present invention described above with reference to FIGS. 1 and 2 will be described in detail. Here, a description overlapped with that of the electrostatic discharge protection device 100 described above will be omitted or simplified.

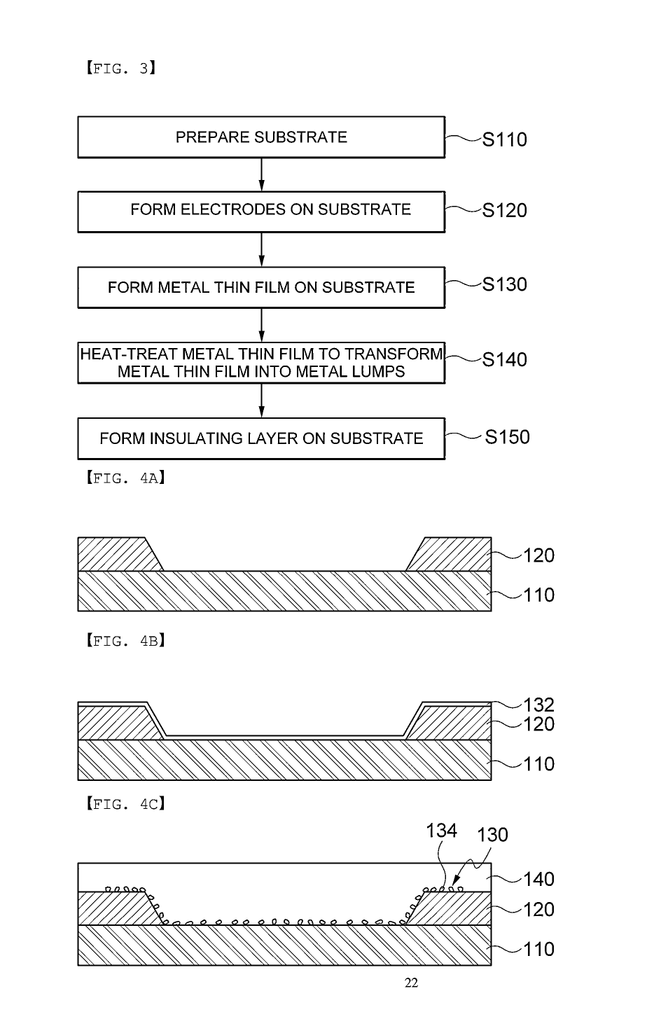

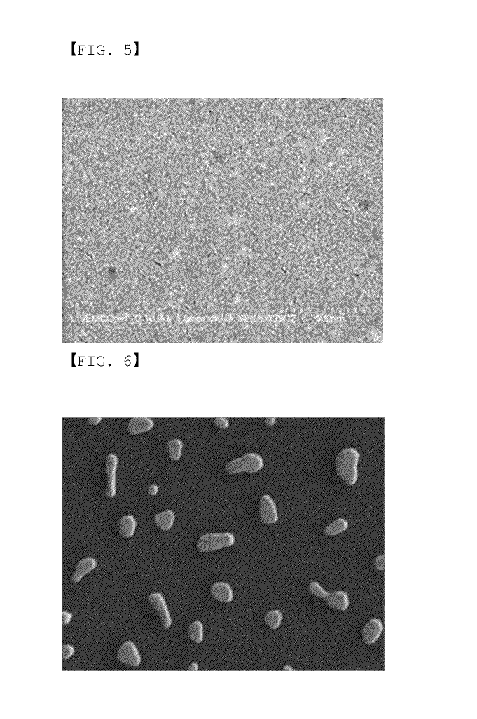

FIG. 3 is a flow chart showing a method for manufacturing an electrostatic discharge protection device according to the exemplary embodiment of the present invention; and FIGS. 4A to 4C are views for describing a process for manufacturing an electrostatic discharge protection device according to the exemplary embodiment of the present invention. Further, FIG. 5 is a photograph showing a metal thin film for forming an electrostatic discharge absorbing layer in the process for manufacturing an electrostatic discharge protection device according to the exemplary embodiment of the present invention; and FIG. 6 is a photograph showing metal lumps of the electrostatic discharge absorbing layer in the process for manufacturing an electrostatic discharge protection device according to the exemplary embodiment of the present invention.

Referring to FIGS. 3 and 4A, the substrate 110 may be prepared (S110). As the substrate 110, at least any one of a ceramic sheet, a varistor sheet, and a liquid crystal polymer may be used. Alternatively, as the substrate 110, a magnetic substrate such as a ferrite substrate may be used.

The electrodes 120 may be formed on the substrate 110 (S120). In the forming of the electrodes 120, a plating process may be performed on the substrate 110 to form plating patterns. To this end, the forming of the electrodes 120 may include forming a resist pattern on the substrate 110, performing a plating process using the resist pattern as a plating prevention film, removing the resist pattern, and the like.

Referring to FIGS. 3 and 4B, the metal thin film 132 may be formed on the substrate 110 (S130). In the forming of the metal thin film 132, a metal film made of at least any one selected from a group consisting of palladium (Pd), rhodium (Rh), silver (Ag), gold (Au), cobalt (Co), tin (Sn), and nickel (Ni) may be formed on surfaces of the substrate 110 and the electrodes 120.

In the forming of the metal thin film 132, a process of forming various kinds of thin films may be performed. As an example, in the forming of the metal thin film 132, a sputtering process using a metal target may be performed on a front surface of the substrate 110 on which the electrodes 120 are formed. As another example, in the forming of the metal thin film 132, an electron beam evaporation process may be performed. In this case, since an electron beam evaporation process apparatus is relatively cheaper than a sputtering process apparatus, a cost required for a process of forming the metal thin film may be decreased. In addition, the metal thin film 132 may be formed using various kinds of physical vapor deposition (PVD) processes such as a thermal evaporation process, a laser molecular beam epitaxy (L-MBE) process, a pulsed laser deposition (PLD), and the like.

Meanwhile, the process of forming the metal thin film 132 may be performed so that the metal thin film 132 has a thickness of about 10 nm to 200 nm. In the case in which the thickness of the metal thin film is less than 10 nm, an amount of metal thin film for forming the metal lumps 134 is significantly small. When heat treatment is performed on this metal thin film, metal lumps having electrical conductivity lower than minimum electrical conductivity for subsequently performing a function as a functional layer may be formed. In this case, the metal lumps has a width less than about 50 nm or an occupied area less than about 5%, it may be difficult to implement the metal lumps as the functional layer. On the other hand, when the thickness of the metal thin film 132 exceeds 200 nm, an amount of metal thin film 132 for forming the metal lumps 132 is significantly large. When heat treatment is performed on this metal thin film, metal lumps having electrical conductivity exceeding maximum electrical conductivity for subsequently performing a function as a functional layer may be formed. In this case, the metal lumps has a width exceeding about 1 μm or an occupied area exceeding about 85%, it may be difficult to implement the metal lumps as the functional layer.

A metal thin film as shown in FIG. 5 may be formed through the process of forming the metal thin film as described above. The metal thin film shown in FIG. 5 is a gold (Au) metal thin film formed by performing a sputtering process.

Referring to FIGS. 3 and 4C, the metal thin film 132 (See FIG. 4B) may be heat-treated to thereby be transformed into the metal lumps 134 (S140). The heat treatment of the metal thin film 132 may be performed by heating the metal thin film 132 at a temperature of 300 to 500° C. In the case in which the heating temperature of the metal thin film 132 is less than 300° C., it is less than a minimum temperature at which the metal thin film 132 may be transformed into the metal lumps, such that it may be difficult to transform the metal thin film 132 into the metal lumps 134 to be implemented as the functional layer. In this case, the metal thin film may not be transformed in a form of metal grain and may be hardly different from an initial metal thin film. On the other hand, in the case in which the heating temperature of the metal thin film 132 exceeds 500° C., it exceeds a maximum temperature at which the metal thin film 132 may be transformed into the metal lumps, the metal thin film 132 may not be transformed into the metal lumps 134 having a form appropriate for being implemented as the functional layer. Particularly, in this case, the metal lumps is not transformed in a form in which a width thereof is larger than a height thereof, but may be deformed in a form in which the height thereof is similar to or larger than the width thereof, that is, a form of grain similar to a sphere.

The electrostatic discharge absorbing layer 130 formed of the metal lumps 134 that may be implemented as the functional layer may be formed on the substrate 110 through the above-mentioned heat treatment process. The metal lumps shown in FIG. 6 are results formed by heating the sputtering gold metal thin film shown in FIG. 5 under a temperature atmosphere of about 400° C. for about one hour. Referring to FIG. 6, the metal lumps are formed in an atypical form so as to have irregular distribution. In this case, the metal lumps do not have a complete spherical shape, but has substantially a form in which a width thereof is slightly larger than an upper height thereof.

After the electrostatic discharge absorbing layer 130 as described above is formed, the insulating layer 140 may be formed on the substrate 110 (S150). In the forming of the insulating layer 140, an insulating film made of various kinds of resins such as a polyimide resin or a polymer resin may be formed on the substrate 110.

As described above, in the method for manufacturing an electrostatic discharge protection device according to the exemplary embodiment of the present invention, the metal thin film 132 is formed on the substrate 110 on which the electrodes 120 are disposed to be spaced apart from each other and is then subjected to a heat-treatment process, thereby making it possible to form the metal lumps 134 that may be implemented as the functional layer. In this case, the distribution, the occupied area, the vertical height, the horizontal width, and the like, of the metal lumps 134 are adjusted to adjust the electrical conductivity of the electrostatic discharge absorbing layer 130, thereby making it possible to adjust the performance of the functional layer, as compared with the case in which the metal thin film is simply implemented as the functional layer. Therefore, in the method for manufacturing an electrostatic discharge protection device according to the exemplary embodiment of the present invention, the functional layer formed of the metal lumps generating the current path allowing the surge current to flow to the ground layer at the time of the generation of the surge current is provided, thereby making it possible to manufacture the electrostatic discharge protection device having high electrostatic discharge characteristics and improved manufacturing efficiency as compared with the case in which the functional layer only in a metal thin film form or the functional layer in a metal-resin composite form is provided.

Since the electrostatic discharge protection device according to the exemplary embodiment of the present invention includes the metal lumps generating the current path allowing the surge current to flow the ground layer at the time of generation of the surge current, the electrical conductivity may be easily adjusted as compared with the case in which the functional layer is implemented using a single metal thin film, and a problem that it is difficult to uniformly distribute metal powders in a metal-resin composite may be solved as compared with the case in which the functional layer is implemented using the metal-resin composite, or the like.

In the method for manufacturing an electrostatic discharge protection device according to the exemplary embodiment of the present invention, the functional layer formed of the metal lumps generating the current path allowing the surge current to flow to the ground layer at the time of the generation of the surge current is provided, thereby making it possible to manufacture the electrostatic discharge protection device having high electrostatic discharge characteristics and improved manufacturing efficiency as compared with the case in which the functional layer only in a metal thin film form or the functional layer in a metal-resin composite form is provided.

The present invention has been described in connection with what is presently considered to be practical exemplary embodiments. In addition, the above-mentioned description discloses only the exemplary embodiments of the present invention. Therefore, it is to be appreciated that modifications and alterations may be made by those skilled in the art without departing from the scope of the present invention disclosed in the present specification and an equivalent thereof. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. An electrostatic discharge protection device comprising:
a substrate;
electrodes disposed to be spaced apart from each other on the substrate; and
an electrostatic discharge absorbing layer having atypical metal lumps formed on the substrate.

2. The electrostatic discharge protection device according to claim 1, wherein each of the metal lumps is made of any one metal selected from a group consisting of palladium (Pd), rhodium (Rh), silver (Ag), gold (Au), cobalt (Co), nickel (Ni), and copper (Cu).

3. The electrostatic discharge protection device according to claim 1, further comprising an insulating layer covering the substrate and the electrodes, wherein the metal lumps are formed along an interface between the substrate and the insulating layer.

4. The electrostatic discharge protection device according to claim 1, wherein the metal lumps are irregularly distributed on the substrate and the electrode.

5. The electrostatic discharge protection device according to claim 1, wherein the metal lumps have a width of 50 nm to 1 μm.

6. The electrostatic discharge protection device according to claim 1, wherein an occupied area of the metal lumps is 5 to 85% with respect to the substrate.

7. The electrostatic discharge protection device according to claim 1, wherein the metal lumps are results formed by performing heat treatment on a metal thin film covering the substrate.

8. The electrostatic discharge protection device according to claim 1, further comprising an insulating layer covering the electrodes, wherein the insulating layer is made of a resin based material.

9. A method for manufacturing an electrostatic discharge protection device, the method comprising:
preparing a substrate;
forming electrodes disposed to be spaced apart from each other on the substrate;
forming a metal thin film covering the substrate; and
heat-treating the metal thin film to transform the metal thin film into atypical metal lumps.

10. The method according to claim 9, wherein in the forming of the metal thin film, at least any one of a sputtering process, an electron beam evaporation process, a thermal evaporation process, a laser molecular beam epitaxy (L-MBE) process, and a pulsed laser deposition (PLD) is performed.

11. The method according to claim 9, wherein the metal thin film is formed to have a thickness of 10 nm to 200 nm.

12. The method according to claim 9, wherein the heat-treating of the metal thin film includes heating the metal thin film at a temperature of 300 to 500° C.

13. The method according to claim 9, wherein the heat-treating of the metal thin film is performed so that the metal lumps has a width of 50 nm to 1 μm.

14. The method according to claim 9, wherein the heat-treating of the metal thin film is performed so that an occupied area of the metal lumps is 5 to 85% with respect to the substrate.
